(19) United States
(12) Patent Application Publication
(10) Pub. No.: US 2007/0016929 A1
(43) Pub. Date: Jan. 18, 2007

(54) CREATING SERIALIZED MEDIA CONTENT

(76) Inventors: Darren L. Wesemann, North Salt Lake, UT (US); Jeffrey C. Hays, Sandy, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/425,380

(22) Filed: Jun. 20, 2006

Related U.S. Application Data
(63) Continuation-in-part of application No. 11/383,921, filed on May 17, 2006.
(60) Provisional application No. 60/682,361, filed on May 18, 2005.

(51) Int. Cl. H04N 5/445; H04N 7/10; G06F 3/00; G06F 13/00; H04N 7/025

(52) U.S. Cl. 725/46; 725/45; 725/34; 725/35

(57) ABSTRACT

Generating serialized media content for a subscriber. A subscriber has access to a database that includes content from multiple subject matter experts. A subset of content is identified based on the subscriber's attributes. Specific content from the subset of content is then selected and used to generate individualized media content. The subscriber can then provide feedback that is used to generate subsequent instances of media content. The feedback is used to identify another subset of content from the database that accounts for the subscriber's feedback.

### CROSS-REFERENCE TO RELATED APPLICATIONS

This application is a continuation in part of U.S. patent application Ser. No. 11/383,921 filed May 17, 2006 and entitled MIXING AND PRODUCING INDIVIDUALIZED MEDIA FILES, which application claims the benefit of U.S. Provisional Patent Application Ser. No. 60/682,361 filed May 18, 2005. The foregoing applications are incorporated herein by reference in their entirety.

### BACKGROUND OF THE INVENTION

1. The Field of the Invention

The present invention relates to personalized media content. More particularly, embodiments of the invention relate to systems and methods for creating individualized media content including serialized media content.

2. The Relevant Technology

People have always been involved in various activities for various reasons. One f the reasons that people repeatedly engage in a particular activity is to improve. One of the best ways to achieve good results or to improve in a given activity is to seek advice or suggestions from someone that is an expert in the relevant subject. For example, cooking schools have expertise in teaching people to cook, colleges provide professors for a wide variety of subjects, travel agents are familiar with trip destinations, and trainers are able to improve the way one exercises.

The experience and expertise of a subject matter expert can help us in a variety of ways. Subject matter experts, for example, often have the ability of being able to identify a preferred course of conduct or a preferred course of study. One of the attractions of personal trainers, and of fitness clubs in general, is their ability to motivate their subscribers and to achieve better results than the subscriber can alone.

Unfortunately, seeking and obtaining the service of a subject matter expert can often prove difficult and expensive. For example, one wanting to achieve a fitness goal would probably seek a trainer, who is a subject matter expert for exercise or fitness. There are several reasons, however, that may prevent one from seeking the assistance of a personal training. The cost of personal trainers, the high demand for personal trainers, scheduling conflicts, travel issues, and the like are examples of reasons why a particular subscriber may not be able to find and benefit from the experience and expertise of a personal trainer. As a result, may subscribers are left without the support and instruction needed to achieve desired fitness goals.

One attempt to fill this void can be found, for example, in DVDs and videocassettes. For example, people that want to exercise in their own homes can easily secure the necessary exercise equipment and can exercise to a workout DVD. Even though the DVD may have content that may have been prepared by a subject matter expert, it is difficult if not impossible to alter the content of the DVD. In other words, the DVD is typically mass produced and is not individualized for a particular user.

A DVD is often unable to dynamically adapt to the changing circumstances of a user. Thus, the needs of a particular subscriber may be only partially satisfied, especially when the subscriber advances past what the DVD has to offer. In other words, a DVD does not target specific individuals or the needs of specific individuals, but is typically targeted at a wide audience A DVD cannot receive feedback from a user that can be used to dynamically generate a new DVD. Even though a user may be able to select a difficulty level, there is no mechanism that enables the DVD to adapt to the user's feedback directly and to tailor the DVD specifically for a particular user.

The ability to bring the expertise of a subject matter expert in a dynamic way is lacking in existing technology and there is therefore a need to create instructions and personalized content in a portable medium to allow a subscriber to take a personalized media content with them in any location and for any subject. More particularly, there is a need to serialize personalized media content that accommodates and incorporates feedback from the subscriber.

### BRIEF SUMMARY OF THE INVENTION

These and other limitations are overcome by embodiments of the invention, which relate to systems and methods for generating serialized media content. Serialized media content refers, in one example, to multiple instances of individualized media content. At least some of the instances of media content are generated in a manner that accounts for feedback provided in response to prior instances of the individualized media content.

Embodiments of the invention enable a subscriber to provide feedback that can be used to generate successive instances of individualized media content. The feedback, combined with the modeling of the content provided by subject matter experts, enables an expert system to generate successive instances of personalized media content that enable the user to improve or progress. In one embodiment, the expert system can provide the expertise (e.g., new exercises, new suggestions, adapting media content to user performance, etc.) of a subject matter expert in the media content.

In one example, a subscriber has access to a knowledge base (e.g., a relational database) of an expert system that includes content for a particular subject from multiple subject matter experts. A query is performed on the knowledge base using the subscriber's attributes. All of the content that matches at least one of the subscriber's attributes can be identified. The subset is distilled or filtered using one or more rules down to the content needed to fill a template. The template thus represents content that, when mixed, results in individualized media content that can be delivered to the subscriber. After the template is filled, the corresponding media clips can be mixed and delivered to the subscriber.

The subscriber can then provide feedback to the expert system that describes the subscriber's experience with the individualized media content. The feedback is used by the expert system to identify content from the knowledge base that accounts for the subscriber's feedback. Thus, the subset of content that is viewed as appropriate for a particular subscriber changes as feedback is received and/or as the subscriber updates his or her attributes. This process can be iterative such that a user can continually receive new media content or different media content. In the context of exercise, for example, the expert system can generate varied media content (e.g., using different exercises) that gradually increase in difficulty, stamina, or in other ways that are consistent with the subscriber's stated goals.

Additional features and advantages of the embodiments disclosed herein will be set forth in the description which follows, and in part will be obvious from the description, or may be learned by the practice of the invention. The features and advantages of the embodiments disclosed herein may be realized and obtained by means of the instruments and combinations particularly pointed out in the appended claims. These and other features of the embodiments disclosed herein will become more fully apparent from the following description and appended claims, or may be learned by the practice of the embodiments disclosed herein as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is an illustration of an expert system that uses a knowledge base to generate individualized media content for a subject;

FIG. 2 illustrates an example of an environment for implementing embodiments of the invention;

FIG. 3 illustrates one embodiment of a process for providing feedback and for requesting media content from an expert system;

FIG. 4 illustrates one embodiment of a method for generating serialized media content where successive instances of media content adapt to or account for user feedback; and

FIG. 5 illustrates one embodiment of a system for mixing content from multiple sources to generate media content including serialized media content.

### DETAILED DESCRIPTION OF THE INVENTION

Embodiments of the invention relate generally to systems, methods, and/or computer program products for creating serialized media content. Embodiments of the invention more particularly relate to the dynamic creating of serialized media content using input from subscribers. Serialized media content provides a subscriber with content that is adapted to the abilities or performance of a subscriber. The ability to adapt or to provide new or changing content ensures that a subscriber can continue to progress or continue to have access to different content in a given subject. Like a personal trainer that can adapt exercise sessions to the performance of a person, embodiments of the invention can produce media content that adapts to the performance of the subscriber. Further the media content can reflect the expertise and philosophies of one or more subject matter experts.

Media content is typically created from a database, referred to herein as a knowledge base, that stores and/or incorporates content from different sources such as subject matter experts. The knowledge base can be adapted to any subject or field. Once the content from the various sources has been incorporated into the knowledge base, the knowledge base can be accessed based on certain parameters, such as a subscriber's attributes, to identify specific instances of the content, such as media clips. The media clips selected or identified from the knowledge base are aggregated and mixed, which results in individualized media content.

The ability to produce additional media content that reflects the performance, for example, of the subscriber uses feedback from the user or feedback that is inferred. Thus, subsequent instances of individualized media content are generated in a similar manner, but can take additional information into account when generating the individualized media content. For example, a user that uses the individualized media content may provide additional information (such as updating attributes or reporting the results of a session where the individualized media content was used, etc.) that can be used in the generation of subsequent instances of media content.

Embodiments of the invention are discussed below with reference to the subject of exercise or fitness. In the context of this subject, trainers are examples of subject matter experts (SMEs) that can provide content that can be modeled and incorporated into the knowledge base. One of skill in the art that the knowledge base can be adapted to other subjects and that appropriate subject matter experts can contribute content relevant to their subject.

As a result, embodiments of the invention can generate individualized media content for a wide variety of different subjects. Exemplary subjects include, but are not limited to, instructional or educational courses or content, sports activities, art, travel, entertainment, and the like or any combination thereof. The subject matter experts are those that have expertise or that have knowledge related to a given subject. For example, a professor or teacher may be a subject matter expert for an educational course, while a travel agent may be a subject matter expert for travel. The subject matter experts can be identified based on the subject of the content included in the knowledge base.

The knowledge base includes content in various forms and formats from multiple users or entities. One of the users or category of users that provides content that is incorporated into the knowledge base, as previously suggested, is a subject matter expert (SME). Some of the SMEs provide content that serves as building blocks, while other SMEs provide content by identifying specific combinations of the building blocks or by providing additional content to the knowledge base. In the context of exercise, for example, the content that serves as building blocks may include generating tables in the knowledge base that define exercise equipment or that define exercises, and the like. Some of the SMEs can then provide content that may incorporate the defined exercise equipment and/or defined exercises into a routine in a manner that expresses the philosophies of the SMEs. For example, one SME may define a treadmill along with the treadmill's settings (maximum speed, maximum incline, etc.). Another SME may use this type of information for an exercise that requires use of the treadmill for a certain amount of time at a certain speed and incline. In this manner, certain SMEs can use the common content as building blocks to generate content that reflects their own expertise and exercise philosophy. Similarly, SMEs in other subjects can provide similar types of content that can be used in a similar manner to generate personalized media content and to serialize the media content with successive instances that account for user performance.

Further, the content provided or organized by the SMEs can be analyzed to identify patterns or philosophies that can be used to generate the individualized media content. This enables an SME to provide information in a first context, for example, that the system can adapt for use in a second context without requiring the SME to provide content for each potential situation or context. For example, the expert system may analyze how the SME handles a medical history with respect to a first exercise and then apply the philosophy to a second exercise or situation. The analysis of content provided by SMEs is further described in U.S. patent application Ser. No. 11/425,372, filed Jun. 20, 2006, which is incorporated herein by reference in its entirety.

Media content, in one embodiment, is an individualized media file that typically can include audio and/or video content. Images may also be included in the media file. Typically the media content includes one or more media clips, each of which may include audio and/or video content, that are selected according to some criteria and then mixed, resulting a personalized media content.

The content received from the subject matter experts is incorporated into the media clips such that, when the individualized media content is delivered, it includes specifically selected content from subject matter experts. Advantageously, subscribers of the media content can receive the benefit of content provided by one or more subject matter experts in any given media content. In this manner, each subscriber can receive individualized media content that reflects the expertise of a SME.

Further, the media content delivered to the subscriber can be serialized to account for the experience of the subscriber with previous media content and/or with attributes of the subscriber that change over time. In other words, a subscriber can provide feedback that is then used in the generation of subsequent instances of media content. As a result, a subscriber is able to request content that is geared specifically for the subscriber.

Embodiments of the invention generate individualized media content that can be directed to a wide variety of activities or subjects. The knowledge base can therefore be created with different subjects in mind and the subject matter experts that contribute to a particular knowledge base are preferably knowledgeable or familiar with that particular subject matter.

Embodiments of the invention are described as they relate to the subject of exercise. In this example, the subject matter experts that contribute to the knowledge base include those that are knowledgeable about exercise, such as exercise trainers and the like. One of skill in the art can appreciate that the knowledge base can be related to other subjects in view of the present disclosure. For example, media content related to a course on algebra may include content from a subject matter expert such as a professor or teacher. Media content related to a trip may include content from a subject matter expert such as a travel guide. One of skill in the art can appreciate, with the benefit of the present disclosure, that the invention can be practiced with many different subjects, including various sessions and activities, in addition to the subject of exercise.

A subscriber that accesses and uses the system described herein ultimately receives individualized media content. When the subject is exercise, the media content delivered to a subscriber may be a workout routine that includes content from one or more subject matter experts. Embodiments of the invention can therefore deliver the expertise of a subject matter expert in the form of personalized media content. Further, the individualized media content can be generated from selectable components stored in the knowledge base.

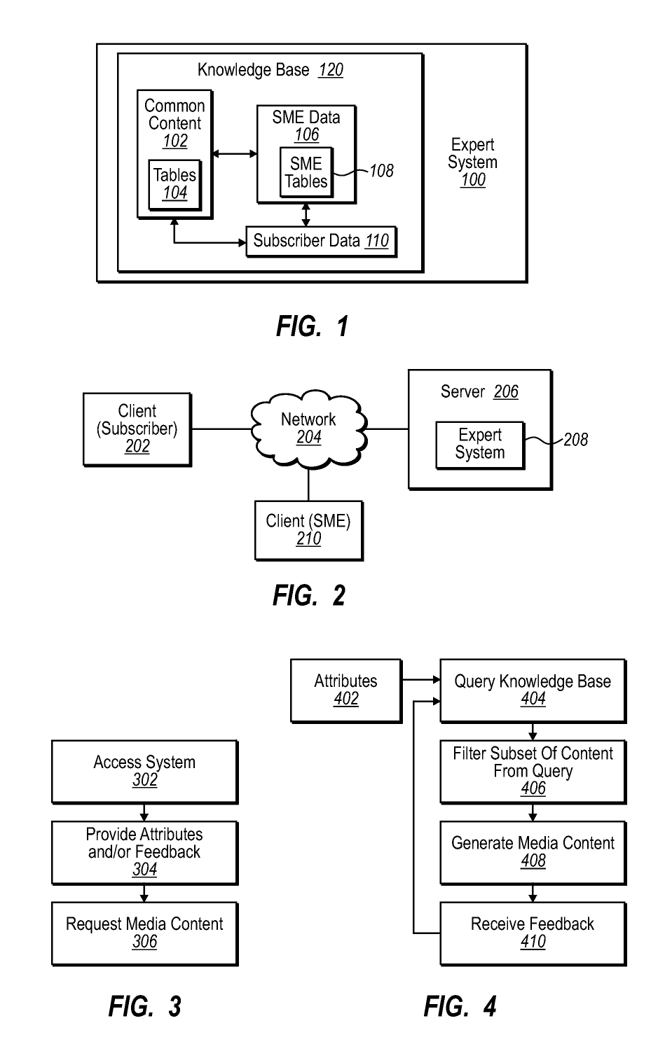

FIG. 1 illustrates one embodiment of an expert system 100 that includes a knowledge base 120. The knowledge base 120 is, in one embodiment, a relational database. The expert system 100 can perform queries and execute rules processing to produce output that conforms to the goals, attributes, and/or status of a subscriber. In one example, the output is individualized media content that can be transmitted to a subscriber and performed on a media device, such as a personal audio/video player, computer, cellular telephone, and the like or any combination thereof.

The knowledge base 120 includes, in this example, common content 102, SME data 106, and subscriber data 110, each of which can be interrelated. The common content 102 is one embodiment of the building blocks of the knowledge base 120 that is typically provided by a first SME or by a group of SMEs that are responsible for generating, updating, maintaining, etc., the common content 102.

The common content 102 includes tables 104 used to store and/or reference various kinds of content in various forms including media clips. Exercises, for example, are defined in the common content 102 in terms of name, description, body part (chest, back, shoulder, biceps, triceps, etc.), equipment, progression (resistance, volume, distance, rate, etc.), and/or clip intro (recorded media). The common content 102 may also include tables related to exercise equipment, age group, cadence, endurance, experience level, frequency, goal, medical event, and the like or any combination thereof.

The SME tables 108 are similar to the tables 104. In one embodiment, the SME tables 108 are used to define methods, which involve the selection of an exercise from the common content 104 and the providing of attributes such as frequency, cadence, reps, sets, rests, age group, medical history, experience level, endurance level, fitness level, availability, and the like or any combination thereof. The methods generated from input from an SME can be stored in the knowledge base 120.

The knowledge base 120 also includes subscriber data 110. The attributes of the each subscriber can include name, gender, height, age group, goal, email, equipment available, medical history, weight, and the like or any combination thereof. Some of the subscriber attributes are variable. Age, weight, goal, email, equipment available, and the like are examples of attributes that may change or that may be changed by a subscriber.

For example, a subscriber may purchase new equipment. By providing this information to the expert system 100, content that was previously not applicable to the subscriber becomes available for use in the generation of the media content. If the subscriber is injured, this information can also be updated in the medical history of the user. Similarly, the subset of content that is selected and used to generate the subscriber's media content changes.

FIG. 2 illustrates an exemplary environment for implementing embodiments of the invention. In this example, a client 202 (such as a subscriber's computer) may access a server 206 (which may represent a server system) over a network 204 such as the Internet. An SME can also access the expert system 208 over the network 204 via the client 210, for example. The expert system 208, which is one example o the expert system 100 in FIG. 1, is implemented on the server 206 or on a server system.

The interface provided to the client 202 or to the client 210 may depend on the identity of the user. As discussed above, different types of users are given access to the expert system 208 for different purposes and a subscriber is usually provided with a different interface than an SME. For example, the interface presented to a subscriber is intended to enable the subscriber to manage the subscriber's attributes and to enable the subscriber to request and receive individualized media content. The interface presented to the SME, on the other hand, is intended to facilitate the entry of content into the expert system 208 or to facilitate the management (add, edit, delete, revise, update etc.) of content in the expert system 208 by an SME.

FIG. 3 is a flow diagram illustrating the process of using the expert system to generate individualized media content. In this example, a subscriber accesses 302 the expert system. This may occur over the Internet using wired and/or wireless networks or various types. For example, a user may access the expert system using a computer, a cellular telephone, or other device. The access may be over a wireless access point or similar connection.

If the subscriber is accessing the expert system for the first time, then the subscriber may provide information to uniquely identify the subscriber (i.e., username and password) for future use of the expert system. If this is the first time using the system, the subscriber may also provide attributes 304 such as those identified above, for example.

If the subscriber has previously registered with the expert system, then providing attributes 304 may include updating the subscriber's attributes. For example, a subscriber may update his or her weight, available equipment, or other attribute that may have an impact on the individualized media content generated by the expert system.

Providing attributes 304 may also include providing feedback to the expert system. The feedback typically relates to information that is related to the use of media content by a subscriber. For example, an expert system can generate individualized media content for a subscriber. After the subscriber uses the individualized media content, the subscriber can provide feedback 304 to the expert system. The serialization of the media content typically includes generating another instance of media content. In one embodiment the next instance of media content accounts for the feedback provided by the subscriber.

The manner of providing feedback can be performed in various ways. The subscriber may be presented with specific questions (e.g., using drop down menus or other data entry methods in a user interface) that are designed to evaluate the subscriber's performance or the subscriber's experience with the media content. In one embodiment, the subscriber may simply indicate that the media content was too easy or too hard.

For example, the expert system may ask the subscriber to enter his or her maximum heart rate during use of the individualized media content, whether the subscriber finished the workout embodied in the media content or other information. Using this information, the expert system can determine if the media content is meeting the subscriber's goal. In this manner, the feedback of the subscriber can be provided to the expert system. After providing feedback or after the expert system infers feedback (from changes in the users attributes, for example), the subscriber can then request new media content that is generated in a manner that accounts for the feedback and/or the updated attributes of the subscriber.

Embodiments of the invention thus contemplate serialized media content such that successive instances of the individualized media content adapt to feedback from the subscriber and/or changing attributes of the subscriber. Further, the expert system may also automatically adapt the serialized content even in situations where the subscriber fails to provide feedback or update attributes. The continued use of the media content, for example, can be used as feedback that can be used in the generation of serialized media content. In this case, the expert system can infer that the subscriber is improving and adjust the media content accordingly.

FIG. 4 illustrates one embodiment of a method for generating serialized media content. The process typically begins by querying 404 the knowledge base. The inputs to the query typically include at least the attributes 402 of the subscriber. When performing the query, the attributes 402 of a subscriber are compared to the content in the knowledge base. When a match of usually at least one attribute occurs, the corresponding content can be included in the content returned by the query. For example, content that is appropriate for a 50 year old person can be identified by the query. In effect, the query identifies a subset of content that is appropriate for inclusion in the media content according to the attributes of the subscriber.

After the subset of content is identified, the subset of content is filtered 406 based on various rules or other system parameters. The rules can account for certain attributes or perform other functions for distilling the subset of content into a set of content that can be used to generate media content. For example, the query of the knowledge base may identify several exercises that are appropriate for a subscriber. The rules can be applied to identify a specific exercise or to identify one or two exercises that are sufficient for a workout routine.

The rules may also be used to fill a template with content. The template, in the context of media content for exercise, may identify each of the clips (an example of content) that are needed to generate an entire workout from the warm up to the warm down. The rules can identify each of the clips needed to fill a template. In one embodiment, the template contains identifiers that are associated with specific clips. After the template is filled, the media clips identified by the template are mixed 408 and delivered to the subscriber. In this manner, an expert system can generate and deliver individualized media content.

When generating serialized media content, the system can then receive 410 feedback from a user. The feedback may include multiple types of information and be submitted in various ways. In one embodiment, a user interface is provided that enables the user to provide input that can be easily interpreted by the expert system. For example, a subscriber may be able to indicate preferences for certain exercise equipment or request longer exercises or request more varied exercises. The subscriber may report on his or her success in completing the workout routine embodied in the media content. Also a subscriber can update his or her attributes. In one embodiment, the feedback is another example of one or more additional attributes.

Feedback is one way for a subscriber to modify the media content that is mixed and delivered to the subscriber. As discussed previously, the subject of the media content can vary. By way of example and in the context of exercise, the individualized media content is a workout routine. Thus, the subscriber's feedback can relate to whether the exercises in the workout routing were completed, how difficult they were, how long it took to finish, and the like or any combination thereof. The feedback provided by the subscriber can be used in the generation of the next installment of media content such that the media content adapts to or accounts for the subscriber's feedback. If the workout routine was too easy, then the feedback insures that the next installment of the serialized media content is more difficult. Similarly, if the subscriber is injured, then an update the to subscriber's medical history also insures that the next installment of the media content accommodates the subscriber's injury. In this manner, the feedback from the subscriber can be used to modify the workout routine to better match the level and improvement of the subscriber. Alternatively, the feedback can be used to simply modify an existing installment of media content rather than generate an entirely new file.

The generation of the next installment of media content repeats the process described above (query the knowledge base, filter the returned content, and generate the media content), with the difference that the query now includes any feedback provided by the subscriber. Because the attributes and/or feedback is different from the previous iteration, the subset of content returned by the query of the knowledge base is also different. Further, the feedback may also be used in the rules used to filter the subset of content returned by the query.

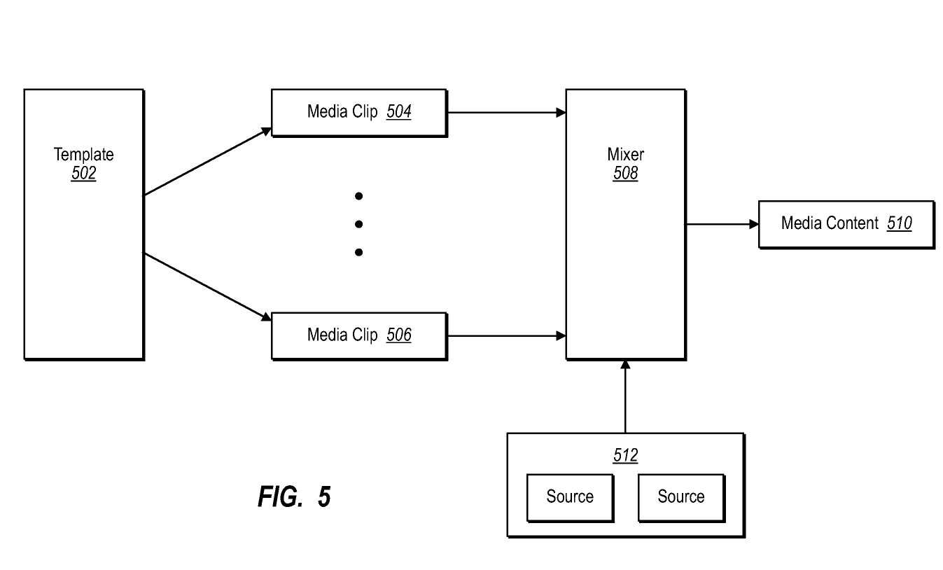

Mixing the media content includes mixing content from multiple sources. FIG. 5 illustrates one embodiment of this process. The template 502, as described above, identifies one or more media clips, represented by the clips 504 and 506. The clips 504 and 506, however, can be mixed with content from other sources 512. The mixer 508 thus receives content from one or more sources and mixes all of the content into the media content 512. In one embodiment, the media content 512 is an audio file (such as an mp3 file) or a file that may include audio and/or video content.

In this example, the sources 512 can be from the expert system, from a library of the subscriber, from another source accessible over a network, and the like or any combination thereof. For example, the sources 512 may be selected as background music to the instruction include in the clips 504 and 506. The mixer 508, in generating the media content 512, may adjust volumes of the various sources of content such that the instruction is not lost in the audio of the sources 512. The mixing performed by the mixer 508 can be performed at the expert system, the client, or at any other suitable location. The media content can be delivered via download, email, and any other delivery method known to one of skill in the art.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a system including a subscriber that has access to a knowledge base for a subject, a method for generating individualized media content for the subscriber regarding the subject, the method comprising:
performing a query on a knowledge base, the knowledge base including content from at least one subject matter expert, wherein the query returns a subset of content;
filtering the subset of content to identify one or more clips for inclusion in an individualized media content;
generating the individualized media content from the one or more clips;
delivering the individualized media content to a subscriber; and
receiving feedback from a subscriber, wherein the feedback is used in the generation of subsequent media content.

2. The method of claim 1, wherein performing a query on a knowledge base further comprises comparing attributes of the subscriber with the content in the knowledge base to identify the subset of content, wherein the subset of content matches at least one of the subscriber's attributes.

3. The method of claim 1, wherein receiving feedback from a subscriber further comprise receiving input from the subscriber regarding performance of the media content.

4. The method of claim 1, wherein receiving feedback from a subscriber further comprises updating one or more of the attributes.

5. The method of claim 1, wherein receiving feedback from a subscriber further comprises presenting the subscriber with an interface that facilitates collection of the feedback in a manner that can be incorporated into the knowledge base.

6. The method of claim 1, wherein filtering the subset of content to identify one or more clips for inclusion in an individualized media content further comprises applying rules to the subset of content, wherein the rules select specific clips for inclusion in the media content.

7. The method of claim 1, wherein generating the individualized media content from the one or more clips further comprises mixing the one or more clips.

8. The method of claim 7, wherein at least one of the one or more clips is from a different source.

9. The method of claim 8, wherein the source of the at least one clip is a web site, an expert system associated with the knowledge base, or a device of the subscriber.

10. The method of claim 9, further comprising repeatedly receiving feedback from the subscriber such that subsequent instances of the media content account for the feedback and/or changing attributes of the subscriber.

11. The method of claim 1, wherein the subject of the knowledge base is exercise and at least a portion of the content in the knowledge base is provided by a subject matter expert that is a trainer.

12. A computer program product having computer executable instructions for performing the method of claim 1.

13. In a system including a subscriber that has access to a knowledge base for a subject, a method for generating serialized media content for the subscriber, the method comprising:
receiving an access request from a subscriber to a knowledge base, the knowledge base including content used to generate individualized media content for a subject;
receiving feedback from the subscriber related to a first instance of media content that was previously provided to the subscriber; and
generating a second instance of media content for the subscriber based at least on the feedback received from the subscriber.

14. The method of claim 13, wherein receiving feedback from the subscriber further comprises updating one or more attributes of the subscriber.

15. The method of claim 13, wherein receiving an access request from a subscriber further comprises uniquely identifying the subscriber.

16. The method of claim 13, wherein generating a second instance of media content further comprises:
querying the knowledge base using at least the feedback and attributes of the subscriber;
returning a subset of content from the knowledge base that matches at least one of the feedback and the attributes;
filtering the subset of content to identify one or more clips for inclusion in the second instance of the media content; and
mixing the one or more clips to generate the second instance of the media content.

17. The method of claim 13, wherein receiving feedback from the subscriber related to a first instance of media content further comprises presenting a user interface to the subscriber that enables an expert system to incorporate the feedback into the knowledge base or into the attributes of the subscriber.

18. The method of claim 13, further comprising generating the second instance of media content by mixing one or more clips from one or more sources of content.

19. The method of claim 18, wherein at least some of the one or more clips are provided by subject matter experts.

20. The method of claim 18, wherein mixing one or more clips from one or more sources of content further comprises mixing the one or more clips at a client and/or at a server system.

21. The method of claim 19, wherein a subject of the knowledge base is exercise and a subject matter expert is a trainer.

22. A computer readable medium having computer executable instructions for performing the method of claim 13.
